(19) United States
(12) Patent Application Publication
(10) Pub. No.: US 2023/0382429 A1
(43) Pub. Date: Nov. 30, 2023

(54) Device and Method for Detecting a Bypass Lane

(71) Applicant: Bayerische Motoren Werke Aktiengesellschaft, Muenchen (DE)

(72) Inventors: Wolfgang HEMPEL, Sinzing (DE); Martin LIEBNER, Muenchen (DE)

(21) Appl. No.: 18/250,902

(22) PCT Filed: Oct. 22, 2021
(86) PCT No.: PCT/EP2021/079363

§ 371 Date: Apr. 27, 2023

(30) Foreign Application Priority Data
Oct. 28, 2020 (DE) 10 2020 128 387.3

(51) Int. Cl. B60W 60/00; B60W 30/18; G01C 21/00

(52) U.S. Cl. CPC B60W 60/0027; B60W 30/18163; G01C 21/3822

(57) ABSTRACT

The invention relates to systems, methods and devices that detect a bypass lane at a junction with at least one traffic light system and control automated longitudinal guidance functions of a motor vehicle based thereon. The driving data of a motor vehicle at the junction is utilized to determine a possible driving trajectory of vehicles at the junction and arrangement information reflecting an arrangement of the traffic light system relative to the possible driving trajectory. The bypass lane of the junction is detected based on the arrangement information, the automated longitudinal guidance functions of the motor vehicle are adjusted based on the bypass lane detection.

### BACKGROUND AND SUMMARY OF THE INVENTION

The invention relates to a device and a corresponding method for detecting a bypass lane at a traffic junction.

A vehicle can have one or more driving functions that assist the driver of the vehicle in the guidance, in particular in the longitudinal guidance and/or in the lateral guidance, of the vehicle. An illustrative driving function for assisting with the longitudinal guidance of a vehicle is the adaptive cruise control (ACC) function, which can be used to perform longitudinal guidance for the vehicle at a stipulated set, or target, speed of travel and/or at a stipulated target distance from a vehicle in front traveling ahead of the vehicle. The driving function can also be used on a signaling unit (in particular at traffic lights) at a traffic junction (for example at an intersection) in order to effect automated longitudinal guidance, for example automated slowing, at the signaling unit.

A signaling unit at a junction (wherein the signaling unit comprises one or more signal transmitters) can be taken into consideration on the basis of map data, the map data comprising one or more map attributes relating to a signaling unit that is to be taken into consideration and/or relating to a junction. In this instance, the quality of the driving function is typically dependent on the quality of the available map data.

The embodiments and principles described herein are therefore concerned in particular with the technical object of increasing the quality of map data relating to a signaling unit and/or relating to a junction in order to increase the convenience and/or safety of a driving function, in particular a driving function for automated longitudinal guidance at a signaling unit or at a junction.

The object is achieved by way of every single one of the independent claims. Advantageous embodiments are described in the dependent claims, inter alia. It is pointed out that additional features of a patent claim that is dependent on an independent patent claim are able, without the features of the independent patent claim or only in combination with a subset of the features of the independent patent claim, to form a separate invention that is independent of the combination of all the features of the independent patent claim and that can be turned into the subject matter of an independent claim, a divisional application or a subsequent application. This applies in the same manner to technical teachings described in the description that are able to form an invention which is independent of the features of the independent patent claims.

According to one aspect, a device for detecting a bypass lane at a junction having at least one traffic signal is described. The device can be a vehicle-external unit. The bypass lane can be a right-turn lane without signal transmitters at the junction. Alternatively, the bypass lane can be a lane on the right next to a left-turn lane, the traffic signal applying to the left-turn lane. The bypass lane can in particular be a lane of the junction without traffic signals.

The device is configured to ascertain travel data pertaining to at least one motor vehicle for at least one journey at the junction. The travel data can comprise environment data from one or more environment sensors (in particular from a camera) of the vehicle and/or trajectory data relating to a travel trajectory of the vehicle for the journey at the junction. The trajectory data can indicate the path or lane of the vehicle for the journey at the junction. The trajectory data can be ascertained using a position sensor (in particular using a GPS receiver) and/or on the basis of the vehicle odometry.

The device can in particular be configured to ascertain travel data from a multiplicity of vehicles and/or for a multiplicity of journeys at the junction, in particular to receive said data from one or more vehicles via a communication connection.

The device is further configured to take the travel data, in particular to take the trajectory data, as a basis for ascertaining at least one possible travel trajectory for vehicles at the junction. The possible travel trajectory can in particular be ascertained on the basis of the trajectory data from the multiplicity of vehicles and/or for the multiplicity of journeys. The trajectory data pertaining to a multiplicity of vehicles and/or a multiplicity of journeys can be taken as a basis for ascertaining e.g. multiple trajectories for vehicles at the junction. It is then possible to verify whether at least one of the trajectories is or could be a bypass lane.

In addition, the device is configured to take the travel data, in particular to take the environment data, as a basis for ascertaining arrangement information relating to the arrangement of the traffic signal of the junction relative to the possible travel trajectory. The device can in particular be configured to take the arrangement information as a basis for detecting that no signal transmitters of the traffic signal are arranged on one side, in particular on the right-hand side, of the possible travel trajectory. Alternatively, or additionally, the device can be configured to take the arrangement information as a basis for detecting that all of the signal transmitters of the traffic signal are arranged to the left of the possible travel trajectory.

A bypass lane of the junction can then be detected on the basis of the arrangement information. In particular, it is possible to determine that the possible travel trajectory is in a bypass lane of the junction (and therefore the possible travel trajectory matches a bypass lane) if the arrangement information is taken as a basis for detecting that no signal transmitters of the traffic signal are arranged on one side, in particular on the right-hand side, of the possible travel trajectory, and/or if the arrangement information is taken as a basis for detecting that all of the signal transmitters of the traffic signal are arranged to the left of the possible travel trajectory.

The device therefore allows a bypass lane to be detected in a reliable manner. The detected bypass lane can then be taken into consideration in the course of a driving function for the automated longitudinal and/or lateral guidance of a vehicle at the junction. This allows the convenience and safety of the driving function to be increased.

The device can be configured to take the detected bypass lane as a basis for creating and/or updating map data for the junction. In particular, a map attribute for a virtual signal group of the traffic signal for the detected bypass lane can be included in the map data. The effect that can be achieved thereby is e.g. that not only one but rather multiple different signal groups are recorded in the map data for the traffic signal. This can have an effect on a driving function, in particular on the level of automation of the driving function, at the junction.

Providing map data that indicate the detected bypass lane allows the convenience and safety of a driving function that uses the map data to be increased further.

According to a further aspect, a vehicle guidance system for providing a driving function for the automated longitudinal guidance of a vehicle at a junction having a traffic signal is described. The vehicle guidance system is configured so as, for a journey on an approach to the junction, to ascertain map data relating to the junction. The map data can be provided e.g. by a vehicle-external unit (e.g. via a communication connection).

The map data can indicate that the traffic signal comprises multiple differently changing signal groups. One of the signal groups can be associated with a bypass lane at the junction (which may be indicated by the map data).

The device can therefore be configured to take the map data as a basis for detecting that the traffic signal of the junction comprises multiple differently changing signal groups. In response thereto, the driving function can be operated in a manual mode, in which the traffic signal, in particular the signaling state of the traffic signal, is taken into consideration for the automated longitudinal guidance of the vehicle at the junction only after confirmation by a user, in particular by the driver, of the vehicle.

On the other hand, the vehicle guidance system can be configured to operate the driving function in an automatic mode at a junction having a traffic signal that has only one signal group, wherein the traffic signal, in particular the signaling state of the traffic signal, is taken into consideration for the automated longitudinal guidance of the vehicle at the junction automatically in the automatic mode.

The mode of the driving function can therefore reliably be made dependent on whether or not the junction has a bypass lane. This allows the convenience and safety of the driving function to be increased.

According to a further aspect, a method for detecting a bypass lane at a junction having at least one traffic signal is described. The method can be carried out by a vehicle-external unit. The method comprises ascertaining travel data pertaining to at least one motor vehicle for at least one journey at the junction, the travel data comprising environment data from one or more environment sensors of the vehicle and/or trajectory data relating to a travel trajectory of the vehicle for the journey at the junction. In addition, the method comprises taking the travel data as a basis for ascertaining a possible travel trajectory for vehicles at the junction, and taking the travel data as a basis for ascertaining arrangement information relating to the arrangement of the traffic signal relative to the possible travel trajectory. The method further comprises detecting a bypass lane of the junction on the basis of the arrangement information.

As already outlined above, the driving function described in this document can in particular be designed to perform automated longitudinal guidance for the vehicle at a and/or in association with a signaling unit (in particular having a signal transmitter). The driving function can be designed in accordance with SAE level 2. In other words, the driving function may provide automated driving and/or driver assistance (relating to longitudinal guidance) in accordance with SAE level 2. The driving function can be limited to the longitudinal guidance of the vehicle. The lateral guidance of the vehicle can be provided manually by the driver or by a further and/or separate driving function (e.g. by a lane keeping assist) during operation.

The driving function can involve automated longitudinal guidance of the vehicle according to a set, or target, speed and/or according to a target distance from a vehicle in front traveling (directly) ahead of the vehicle. For this purpose, the driving function can provide a speed controller that adjusts, in particular regulates, the actual speed of travel of the vehicle according to the set, or target, speed. Alternatively, or additionally, a distance controller can be provided that adjusts, in particular regulates, the actual distance of the vehicle from the vehicle in front according to the target distance. If there is no relevant vehicle in front or if the vehicle in front is traveling faster than the set, or target, speed, the speed of travel of the vehicle can be regulated. Alternatively, or additionally, if the vehicle in front is traveling more slowly than the set or target speed, the distance of the vehicle from the vehicle in front can be regulated. The driving function can therefore be configured to provide an adaptive cruise control (ACC) driver assistance function.

A vehicle can comprise a user interface for an interaction with a user, in particular with the driver, of the vehicle. The user interface can comprise one or more operator control elements that allow the user to stipulate the set, or target, speed and/or the target distance. Alternatively, or additionally, the one or more operator control elements can allow the user to confirm a previously stipulated set and/or target speed and/or a previously stipulated target distance of the vehicle for the operation of the driving function. The one or more operator control elements can be designed to be operated with one hand and/or with one finger of the driver. Alternatively, or additionally, the one or more operator control elements can be arranged on a steering means (in particular on a steering wheel or on a steering frame) of the vehicle.

An illustrative operator control element (in particular a plus/minus operator control element) is a key and/or a rocker that can be used to increase or reduce the set and/or target speed or the target distance. A further illustrative operator control element (in particular a Set operator control element) is a key that can be used to stipulate a current speed of travel of the vehicle as a set and/or target speed or that can be used to stipulate a current distance of the vehicle from the vehicle in front as a target distance. A further illustrative operator control element (in particular a Resume operator control element) is a key that can be used to reconfirm or reactivate a previously selected set and/or target speed or a previously selected target distance.

The user interface can further comprise one or more output elements (e.g. a screen and/or a loudspeaker and/or a vibration element) that can be used to produce outputs to the user of the vehicle.

In addition, the driving function can be configured to take into consideration one or more signaling units on the road (in particular street) and/or travel route used by the vehicle for the automated longitudinal guidance. A signaling unit can be intended to stipulate right of way at a junction (in particular at an intersection) on the road network used by the vehicle. The stipulation of right of way can be variable over time (such as e.g. in the case of a traffic signal, for example in the case of traffic lights, having one or more different signal groups for one or more different directions of travel of the vehicle at the junction) or firmly predefined (such as e.g. in the case of a road sign, for example at a stop sign).

Data relating to a signaling unit ahead in the direction of travel of the vehicle can be ascertained during the operation of the driving function. The data can comprise map data relating to signaling units in the road network used by the vehicle. Each instance of the map data can comprise one or more attributes for a signaling unit. The one or more attributes for a signaling unit can indicate, or comprise:
the type of signaling unit, in particular whether the signaling unit is a traffic signal or a road sign; and/or
the number of different signal groups of the signaling unit for different directions of travel at the junction of the road network at which the signaling unit is arranged, or with which the signaling unit is associated; and/or
the position (e.g. the GPS coordinates) of the signaling unit and/or of the stop line of the signaling unit within the road network; and/or
the relative distance of the stop line from the associated signaling unit.

The driving function can be configured to use a position sensor (e.g. a GPS receiver) of the vehicle and/or to use odometry to ascertain the actual position (e.g. the current GPS coordinates) of the vehicle within the road network. The map data can then be taken as a basis for detecting a (e.g. the next) signaling unit on the travel route of the vehicle. Furthermore, one or more map attributes for the detected signaling unit can be ascertained.

Alternatively, or additionally, the data relating to a signaling unit ahead in the direction of travel of the vehicle can comprise environment data relating to the signaling unit, or can be ascertained on the basis of environment data. The environment data can be captured by one or more environment sensors of the vehicle. Illustrative environment sensors are a camera, a radar sensor, a lidar sensor, etc. The one or more environment data can be configured to capture sensor data (i.e. environment data) for the environment in front of the vehicle in the direction of travel.

The driving function can be configured to take the environment data (in particular to take the sensor data from a camera) as a basis for detecting that a signaling unit is arranged in front of the vehicle in the direction of travel. E.g. an image analysis algorithm can be used for this purpose. In addition, the driving function can be configured to take the environment data as a basis for ascertaining the type of signaling unit (e.g. traffic signal or road sign). Furthermore, the driving function can be configured to take the environment data as a basis for ascertaining the (signaling) state of the signaling unit with regard to permission to cross the junction associated with the signaling unit. In particular, the colors (green, amber or red) of the one or more signal groups of a traffic signal can be ascertained.

The driving function can be configured to take into consideration a detected signaling unit for the automated longitudinal guidance of the vehicle. In particular, the driving function can be configured to take the data relating to the detected signaling unit, in particular to take the color of a light signal or of a signal group of the signaling unit, as indicated by the data, as a basis for determining whether or not the vehicle needs to stop at the signaling unit, in particular at the stop line of the signaling unit. By way of example, it is possible to detect that the vehicle needs to stop, because the signal group relevant to the vehicle is red. Alternatively, it is possible to detect that the vehicle does not need to stop, because the signal group relevant to the vehicle is green. In a further example, it is possible to detect that the vehicle needs to stop, because the signaling unit is a stop sign.

The driving function can further be configured to cause the vehicle to be stopped at the detected signaling unit in an automated manner if it is determined that the vehicle needs to stop at the signaling unit. For this purpose, an automated slowing process (to a standstill) can be produced. This can involve the vehicle being guided up to or in front of the stop line of the signaling unit in an automated manner. During the automated slowing process, the driving function can be used to actuate one or more wheel brakes (e.g. one or more friction brakes or one or more regenerative brakes) in an automated manner, in order to slow the vehicle (to a standstill). The time characteristic for the slowing produced can be dependent on the available braking distance before the detected signaling unit.

Alternatively, or additionally, the driving function can be configured to produce automated longitudinal guidance for the vehicle past the detected signaling unit, in particular over the stop line of the signaling unit, if it is determined that the vehicle does not need to stop at the signaling unit. The speed and/or distance control in this case can be continued according to the set, or target, speed and/or according to the target distance from the vehicle in front.

The driving function can therefore be configured to provide an ACC driving function taking into consideration signaling units. The driving function is also referred to as an urban cruise control (UCC) driving function in this document.

As already outlined earlier, the driving function can be configured to perform automated longitudinal guidance for the vehicle on the basis of a target speed and/or on the basis of a target distance from a vehicle in front traveling ahead of the vehicle, in the course of the operation of the driving function. Furthermore, the driving function can be configured so as, if a (possibly detected) signaling unit is not taken into consideration for the driving function, to produce automated longitudinal guidance for the vehicle past the signaling unit, in particular beyond the stop line of the signaling unit, on the basis of the target speed and/or on the basis of the target distance, in particular irrespective of the color of a light signal of the signaling unit. Optionally, the driving function can therefore (if a signaling unit is not taken into consideration) be operated as if the signaling unit (and the associated junction) did not exist.

Optionally, the driving function can allow the user of the vehicle to configure the driving function by way of the user interface (e.g. in a configuration menu). It is then optionally possible to select whether the driving function is intended to be operated in an automatic mode or is intended to be operated in a manual mode.

In the automatic mode, the driving function can be operated in such a way that a detected signaling unit ahead in the direction of travel is automatically taken into consideration for the operation of the driving function (and may result in automated slowing of the vehicle). In particular, the driving function can be configured in the automated mode to take a signaling unit detected on the basis of map data and/or environment data into consideration for the automated longitudinal guidance of the vehicle automatically, in particular without confirmation from the user of the vehicle (e.g. in order to produce automated slowing of the vehicle at the detected signaling unit when required).

On the other hand, the driving function can be operated in the manual mode in such a way that the detected signaling unit is taken into consideration for the automated longitudinal guidance of the vehicle (and may result in automated slowing of the vehicle) only after confirmation by the user of the vehicle. In particular, the driving function can be configured (by way of the user interface of the vehicle) in the manual mode to output an offer relating to taking the detected signaling unit into consideration to the user of the vehicle. By way of example, the screen can be used to display that a signaling unit has been detected and that an acknowledgement from the user is required (in order to cause the signaling unit to be taken into consideration for the automated longitudinal guidance of the vehicle). The detected signaling unit (in particular the signaling state of the signaling unit) can be taken into consideration for the automated longitudinal guidance of the vehicle at the signaling unit if (in particular only if) the offer is accepted by the user (e.g. by operating an operator control element, in particular the Set operator control element). Automated slowing of the vehicle at the detected signaling unit may then take place. On the other hand, the driving function can be configured to not take into consideration and/or to ignore the detected signaling unit (in particular the signaling state of the signaling unit) for the automated longitudinal guidance of the vehicle at the signaling unit if the offer is not accepted by the user. In this case, the speed and/or distance control can be continued (without taking into consideration the signaling unit, in particular as if the signaling unit were not present).

Providing different (selectable) modes for the operation of the driving function (in particular the UCC driving function) allows the convenience of the driving function to be increased further.

The driving function can be designed to inform the user of the driving function about the status of the driving function using the user interface. In particular, the user of the driving function can be informed about whether or not a detected signaling unit ahead in the direction of travel is taken into consideration for the operation of the driving function, in particular for the automated longitudinal guidance of the vehicle.

The driving function can be configured to determine (e.g. on the basis of the map data and/or the environment data) whether or not a signaling unit ahead in the direction of travel is taken into consideration, or can be taken into consideration, for the operation of the driving function. If the signaling unit is taken into consideration, or can be taken into consideration, an availability output, in particular an availability display, can optionally be output in order to inform the user that the signaling unit ahead is taken into consideration for the automated longitudinal guidance of the vehicle (and therefore automated slowing of the vehicle at the signaling unit takes place when required).

Alternatively, or additionally, the driving function can be configured to produce (if it is determined that the signaling unit ahead is not taken into consideration, or cannot be taken into consideration, for the driving function) an unavailability output, in particular an unavailability display, (via the user interface) in order to inform the user of the vehicle that the signaling unit ahead is not taken into consideration for the automated longitudinal guidance of the vehicle (and therefore no automated slowing of the vehicle on the basis of the signaling state of the signaling unit is produced either).

The output of an availability and/or unavailability output allows the convenience and safety of the driving function to be increased further. The availability and/or unavailability outputs in this case can each comprise a visual, audible and/or haptic output.

The driving function can be configured to determine that the signaling state of the signaling unit's signal group that is relevant to the direction of travel of the vehicle changes (e.g. while the vehicle is traveling toward the signal group, or while the vehicle is stationary at the signal group). By way of example, it is possible to detect that a phase change from red to green takes place.

In addition, the driving function can be configured to cause (in response to the detected phase change) information relating to the changed signaling state of the signal group of the signaling unit to be conveyed to the driver of the vehicle. By way of example, it is possible to cause an output element (in particular on a screen) of the user interface to be used to display a symbol pertaining to the detected signaling unit (optionally taken into consideration for the automated longitudinal guidance) while the signal group has the color red. After a phase change to green has been detected, the displayed symbol can then be optionally cancelled, or the output can be terminated. As such, it is possible to reliably convey to the driver of the vehicle that e.g. after the vehicle has been stationary at the signaling unit an (optionally automated) start-up process can be brought about (e.g. by operating an operator control element of the user interface).

The driving function can be configured to output a takeover request to the driver of the vehicle if the driving function is stopped. By way of example, it is possible to detect that the automated longitudinal guidance cannot be continued or is not continued (on the basis of the set and/or target speed and/or on the basis of the target distance). The driving function can be stopped e.g. if the driver of the vehicle (fundamentally) intervenes in the longitudinal guidance of the vehicle (e.g. by virtue of the driver of the vehicle operating the brake pedal or the gas pedal). A takeover request (TOR) can then be output to the driver of the vehicle. The longitudinal guidance then needs to be produced by the driver again. The output of a takeover request allows the safety of the operation of the vehicle to be increased.

According to a further aspect, a motor (road) vehicle (in particular an automobile or a truck or a bus or a motorcycle) is described that comprises the vehicle guidance system for operating a driving function as described in this document.

According to a further aspect, a software (SW) program is described. The SW program can be configured to be executed on a processor (e.g. on a control unit of a vehicle and/or on a vehicle-external unit), and to thereby carry out at least one of the methods described in this document.

According to a further aspect, a storage medium is described. The storage medium can comprise an SW program that is configured to be executed on a processor, and to thereby carry out at least one of the methods described in this document.

The term “automated driving” can be understood within the context of the document to mean driving with automated longitudinal or lateral guidance or autonomous driving with automated longitudinal and lateral guidance. Automated driving can be for example driving over an extended period of time on the freeway or driving over a limited period of time when parking or maneuvering. The term “automated driving” covers automated driving with any level of automation. Illustrative levels of automation are assisted, semiautomated, highly automated or fully automated driving. These levels of automation have been defined by the German Federal Highway Research Institute (BASt) (see BASt publication “Forschung kompakt”, issue November 2012). In the case of assisted driving, the driver performs the longitudinal or lateral guidance on an ongoing basis, while the system undertakes the respective other function within certain boundaries. In the case of semiautomated driving (TAF), the system undertakes the longitudinal and lateral guidance for a certain period of time and/or in specific situations, the driver needing to monitor the system on an ongoing basis as in the case of assisted driving. In the case of highly automated driving (HAF), the system undertakes the longitudinal and lateral guidance for a certain period of time without the driver needing to monitor the system on an ongoing basis; however, the driver must be capable of taking over vehicle guidance within a certain time. In the case of fully automated driving (VAF), the system can automatically cope with driving in all situations for a specific application; a driver is no longer needed for this application. The aforementioned four levels of automation correspond to SAE levels 1 to 4 of SAE standard J3016 (SAE—Society of Automotive Engineering). By way of example, highly automated driving (HAF) corresponds to level 3 of SAE standard J3016. Furthermore, SAE standard J3016 also has provision for SAE level 5 as the highest level of automation, which is not included in the definition from the BASt. SAE level 5 corresponds to driverless driving, in which the system can automatically cope with all situations throughout the journey in the same way as a human driver; a driver is generally no longer needed. The aspects described in this document relate in particular to a driving function, or a driver assistance function, designed according to SAE level 2.

It should be noted that the methods, devices and systems described in this document can be used alone or in combination with other methods, devices and systems described in this document. Furthermore, any aspects of the methods, devices and systems described in this document can be combined with one another in a variety of ways. In particular, the features of the claims can be combined with one another in a variety of ways.

The invention is described in more detail below with reference to the Figures.

### BRIEF DESCRIPTION OF THE DRAWINGS

FIG. 1 shows illustrative components of a vehicle;

FIG. 2a shows an illustrative traffic signal;

FIG. 2b shows an illustrative road sign;

FIG. 3 shows an illustrative traffic situation;

FIG. 4 shows an illustrative user interface;

FIGS. 5a and 5b show illustrative bypass lanes at a junction; and

FIG. 6 shows a flowchart for an illustrative method for detecting a bypass lane at a junction.

### DETAILED DESCRIPTION OF THE DRAWINGS

As outlined at the outset, described herein are systems and methods for increasing the reliability, availability and/or convenience of a driving function, in particular of a driver assistance system, of a vehicle, e.g. in association with a signaling unit at a junction of the road used by the vehicle. In particular, the such systems and methods are concerned with providing precise map data for operating a driving function.

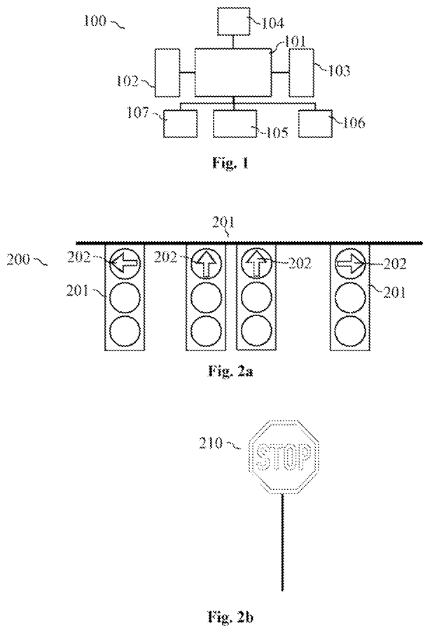

FIG. 1 shows illustrative components of a vehicle 100. The vehicle 100 comprises one or more environment sensors 103 (e.g. one or more image cameras, one or more radar sensors, one or more lidar sensors, one or more ultrasonic sensors, etc.) that are configured to capture environment data relating to an environment of the vehicle 100 (in particular relating to the environment in front of the vehicle 100 in the direction of travel). In addition, the vehicle 100 comprises one or more actuators 102 that are configured to influence the longitudinal and/or lateral guidance of the vehicle 100. Illustrative actuators 102 are a brake system, a drive motor, a steering system, etc.

The control unit 101 can be configured to take the sensor data from the one or more environment sensors 103 (i.e. to take the environment data) as a basis for providing a driving function, in particular a driver assistance function. By way of example, the sensor data can be taken as a basis for detecting an obstacle on the travel trajectory of the vehicle 100. The control unit 101 can then control one or more actuators 102 (e.g. the brake system) in order to slow the vehicle 100 in an automated manner and thereby prevent the vehicle 100 from colliding with the obstacle.

In particular in the course of the automated longitudinal guidance of a vehicle 100, one or more signaling units (e.g. a traffic signal and/or a road sign) on the road or street used by the vehicle 100 can be taken into consideration besides a vehicle in front. In particular the status of a traffic signal or traffic light can be taken into consideration, with the result that, at a red traffic light relevant to the specific (planned) direction of travel, the vehicle 100 effects slowing to the stop line of the traffic light and/or speeds up (again, if applicable) for a green traffic light in an automated manner.

Traffic signals can be of very heterogeneous design in different countries and moreover be of different complexity in terms of assignment of direction-of-travel lights. As such, different directions of travel can be controlled collectively by a first group of signals or by a signal group and another direction can be controlled by a different signal group. The repeating signals of a signal group can furthermore be geographically situated at different points of an intersection. It can therefore be difficult for a control unit 101 (also referred to as vehicle guidance system in this document) to take the sensor data as a basis for detecting which one or more signals of a traffic signal at an intersection are relevant to the planned direction of travel of the vehicle 100 and which are not (in particular if the vehicle 100 is still a relatively long way from the traffic signal).

FIG. 2a shows an illustrative traffic signal 200. The traffic signal 200 illustrated in FIG. 2a has four different signal transmitters 201 arranged at different positions at an approach to an intersection. The left-hand signal transmitter 201 has an arrow 202 to the left, and thus indicates that this signal transmitter 201 applies to left turns. The two middle signal transmitters 201 have an upward arrow 202 (or no arrow 202) and thus indicate that these two signal transmitters 201 apply to driving straight ahead. The individual light signals of these two signal transmitters 201 form signal groups. In addition, the right-hand signal transmitter 201 has an arrow 202 to the right, and thus indicates that this signal transmitter 201 applies to right turns.

The traffic signal 200 illustrated in FIG. 2a is only one example of many different possible embodiments of a traffic signal 200. A traffic signal 200 can have a relatively large number of different forms of features. Illustrative features are
the number of signal transmitters 201 and/or signal groups;
the positions of the one or more signal transmitters 201; and/or
the assignment of a signal transmitter 201 to a possible direction of travel through an intersection.

FIG. 2b shows an illustrative stop sign as a road sign 210 that controls right of way at a traffic junction, in particular at an intersection. The control unit 101 of the vehicle 100 can be configured to take the sensor data from the one or more environment sensors 103 (i.e. to take the environment data) and/or to take digital map information (i.e. map data) as a basis for detecting a road sign 210 relevant to the right of way of the vehicle 100 on the street or road used by the vehicle 100.

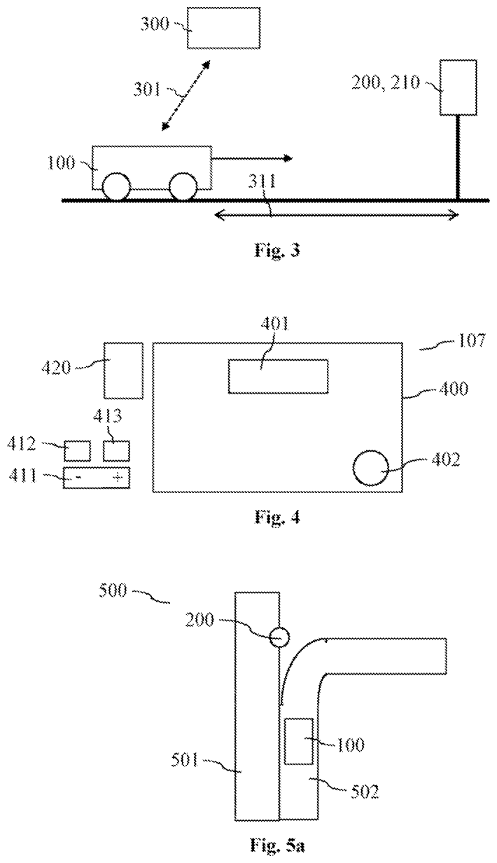

FIG. 3 shows, by way of illustration, a vehicle 100 that is moving toward a signaling unit 200, 210 (in particular toward a traffic signal 200 and/or toward a road sign 210) on a road. The one or more environment sensors 103 of the vehicle 100 can be configured to capture sensor data (in particular image data) relating to the signaling unit 200, 210. The sensor data can then be analyzed (e.g. by means of an image analysis algorithm) in order to ascertain forms of one or more features of the signaling unit 200, 210. In particular, the sensor data can be taken as a basis for ascertaining whether the signaling unit 200, 210 is a traffic signal 200 or a road sign 210. Furthermore, it is possible to ascertain which signal transmitter 201 of the traffic signal 200 is relevant to the (planned) direction of travel of the vehicle 100. In addition, the (signaling) state of the relevant signal transmitter 201 (e.g. the color, for example red, amber or green) can be ascertained.

The quality and/or reliability with which the environment data can be taken as a basis for ascertaining the form of a feature of a signaling unit 200, 210 are typically dependent on the distance 311 of the vehicle 100 from the signaling unit 200, 210. In addition, current weather conditions also typically have a significant influence on the quality and/or reliability of the ascertained form of a feature. Moreover, the quality and/or reliability can be different for different features.

The vehicle 100 can have a storage unit 104 that stores digital map information (i.e. map data) relating to the street network used by the vehicle 100. The map data can indicate forms of one or more features of one or more signaling units 200, 210 in the street or road network as attributes.

In particular, the map data can indicate for a traffic signal 200 the assignment of the one or more signal transmitters 201 or signal groups to different possible directions of travel. In other words, the map data can indicate which signal transmitter 201 or which signal group is responsible for clearance for which direction of travel. The map data may be received at the vehicle 100 by means of a communication unit 105 of the vehicle 100 via a wireless communication connection (e.g. a WLAN or LTE communication connection).

The control unit 101 of the vehicle 100 can be configured to ascertain (e.g. on the basis of the current position of the vehicle 100 and on the basis of a planned travel route and/or on the basis of the environment data from the one or more environment sensors 103) that the vehicle 100 is approaching a signaling unit 200, 210 ahead. In addition, the control unit 101 can take the (stored and/or received) map data as a basis for ascertaining the forms of one or more features of the signaling unit 200, 210 ahead. In particular, the map data can be taken as a basis for ascertaining which signal transmitter 201 or which signal group of a traffic light 200 is associated with the current or planned direction of travel of the vehicle 100. Additionally, the environment data can be taken as a basis for ascertaining the current status of the associated signal transmitter 201 or the associated signal group. This can then be taken as a basis for performing an automated driving function (e.g. automated longitudinal guidance of the vehicle 100) reliably and conveniently. In particular, taking into consideration the map data allows the forms of the one or more relevant features of a signaling unit 200 to be ascertained even if the vehicle 100 is at a relatively long distance 311 from the signaling unit 200, allowing the reliability, availability and convenience of an automated driving function to be increased.

A vehicle 100 can be configured to use information relating to a signaling unit 200, 210 that is or has been passed by the vehicle 100 to create and/or add to the map data. The map data can be created and/or added to locally by way of the vehicle 100 and/or centrally by way of a vehicle-external unit 300 (e.g. by way of a backend server) (see FIG. 3). In direct proximity to a signaling unit 200, 210, the one or more environment sensors 103 of a vehicle 100 can typically be used to capture environment data that indicate the form of one or more features of the signaling unit 200, 210 in a precise manner. In particular, in direct proximity, the captured environment data can be taken as a basis for determining the association between signal transmitters or signal groups 201 and possible directions of travel in a precise and reliable manner.

The vehicle 100 can be configured to transfer the ascertained information (e.g. the environment data and/or the ascertained forms of the one or more features) to the vehicle-external unit 300 via a wireless communication connection 301 (in conjunction with an identifier for the respective signaling unit 200, 210, for example in conjunction with the position of the signaling unit 200, 210). The vehicle-external unit 300 can then take the information provided by a multiplicity of vehicles 100 as a basis for creating and/or updating map data that respectively indicate the forms of one or more features for a multiplicity of different signaling units 200, 210 as attributes. The map data can then be provided to the individual vehicles 100 in order (as outlined above) to assist in the operation of an automated driving function.

The vehicle 100 typically comprises a user interface 107 having one or more operator control elements and/or having one or more output elements. FIG. 4 shows an illustrative user interface 107 having a display unit 400, in particular having a screen, for outputting visual information. The display unit 400 can be used to output, e.g. using a display element 401, a proposal for the automated guidance of the vehicle 100 at a signaling unit 200, 210 ahead. Alternatively, or additionally, a display element 402 may be provided that is used to show the status of the driving function (e.g. active or inactive).

Alternatively, or additionally, the user interface 107 can comprise at least one loudspeaker 420 as an output element, which can be used to output an audible output (e.g. a warning tone) to the driver of the vehicle 100.

In addition, the user interface 107 can comprise one or more operator control elements 411, 412, 413 that allow the driver of the vehicle 100 to activate and/or parameterize the driving function. An illustrative operator control element is a rocker 411 that allows the driver to stipulate, in particular to increase or reduce, a set speed (i.e. a target speed of travel) for the vehicle 100. A further illustrative operator control element is a Set operator control element 412 that allows the driver to stipulate the current speed of travel as a set speed and/or to accept a proposal for the automatic guidance of the vehicle 100 at a signaling unit 200, 210 ahead (e.g. in the manual mode of the driving function). Furthermore, the user interface 107 can comprise a Resume operator control element 413 that allows the driver e.g. to reactivate the driving function with a previously stipulated set speed.

The control unit 101 of the vehicle 100 can be designed to provide automated longitudinal guidance of the vehicle 100 in towns. This driving function can be referred to e.g. as an urban cruise control (UCC) driving function. The driving function can be provided in an automatic mode (aUCC) and/or in a manual mode (mUCC) in this case. The driver may be allowed to use the user interface 107 to stipulate whether the driving function is intended to be operated in the automatic mode or in the manual mode.

The control unit 101 of the vehicle 100 can be configured to take the environment data from the one or more environment sensors 103 and/or to take the map data (in conjunction with the position data from the position sensor 106 of the vehicle 100) as a basis for detecting a signaling unit 200, 210 ahead on the travel route of the vehicle 100. In the manual mode of the UCC driving function, a proposal or a request concerning whether or not the signaling unit 200, 210 is to be taken into consideration for the automated longitudinal guidance of the vehicle 100 can then be output via the user interface 107. The driver of the vehicle 100 can then accept or reject, or ignore, the proposal, e.g. by operating the Set operator control element 412. On the other hand, in the automatic mode of the UCC driving function, the detected signaling unit 200, 210 may be taken into consideration for the automated longitudinal guidance of the vehicle 100 automatically (i.e. without acknowledgement being required from the driver).

If the detected signaling unit 200, 210 is taken into consideration for the automated longitudinal guidance of the vehicle 100, then (depending on the type and/or (signaling) state of the signaling unit 200, 210) automatic slowing can be produced in order to bring the vehicle 100 (e.g. at red traffic lights or at a stop sign) to a standstill in an automated manner. Furthermore, automatic startup of the vehicle 100 can be brought about (e.g. after the (signaling) state of the signaling unit 200, 210 has changed, for example after a change to green). The vehicle 100 can then be accelerated to the set speed, again in an automated manner (taking into consideration a stipulated minimum or target distance from a vehicle in front).

The UCC driving function can therefore be used to allow the driver of a vehicle 100 to use the ACC driving function even on a road having one or more signaling units 200, 210 (without having to deactivate and reactivate the ACC function at each of the individual signaling units 200, 210).

The control unit 101 can be configured to take the environment data and/or to take the map data as a basis for determining whether or not a signaling unit 200, 210 ahead can be taken into consideration for the automated longitudinal guidance. If it is determined that the signaling unit 200, 210 ahead cannot be taken into consideration for the automated longitudinal guidance, an output (e.g. a visual output using a display unit 400, 402) to the driver of the vehicle 100 can be produced in order to inform the driver of the vehicle 100 that the signaling unit 200, 210 ahead cannot be taken into consideration for the automated longitudinal guidance. This display can be referred to as an “unavailability display”. It is then the task of the driver of the vehicle 100 to slow the vehicle 100 before the signaling unit 200, 210 as required (e.g. because the traffic lights change to red, or because the signaling unit 200, 210 is a stop sign).

In addition, the control unit 101 can be configured to detect during the operation of the UCC driving function that the vehicle 100 cannot (now) have longitudinal guidance performed for it in an automated manner (e.g. because the driver has manually intervened in the longitudinal guidance of the vehicle 100). In this case, a takeover request (TOR) can be output to the driver of the vehicle 100 in order to prompt the driver to manually take over the longitudinal guidance of the vehicle 100.

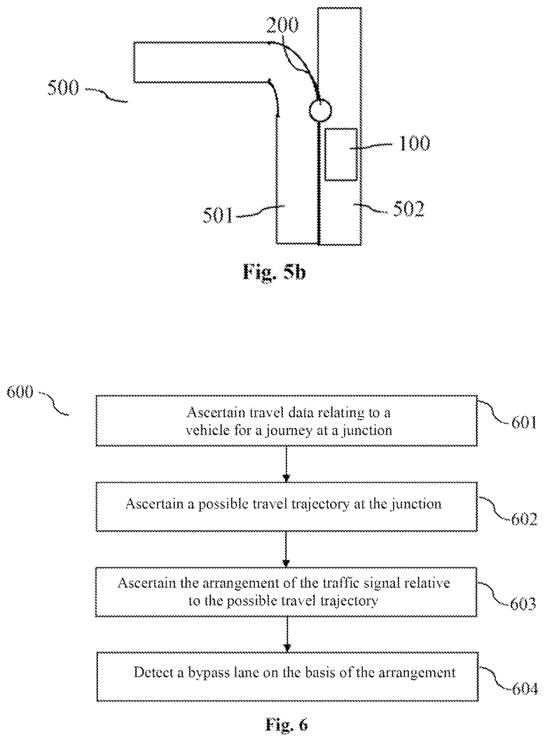

FIGS. 5a and 5b each show an illustrative junction 500 having a signaling unit 200 in a first lane 501. In addition, the junction 500 has a bypass lane 502 that goes past the signaling unit 200 (in particular the signal transmitter 201 of the signaling unit 200). In the example illustrated in FIG. 5a, the bypass lane 502 is a right-turn lane, whereas the signaling unit 200 is arranged in a straight-ahead lane. In the example illustrated in FIG. 5b, the bypass lane 502 is a straight-ahead lane, whereas the signaling unit 200 is arranged in a left-turn lane (what is known as a “protected left turn” junction 500).

The vehicle guidance system 101 of a vehicle 100 can be configured to take the environment data from the one or more environment sensors 103 of the vehicle 100 as a basis for detecting a signaling unit 200 at the junction 500 ahead. In addition, the signaling state of the signaling unit 200 can be ascertained. It is then possible to produce automated longitudinal guidance at the junction 500 on the basis of the detected signaling state of the signaling unit 200. In particular, automated slowing of the vehicle 100 can be produced e.g. for red.

At a junction 500 having a bypass lane 502, the signaling state of the signaling unit 200 should be taken into consideration only if the vehicle 100 is in a lane 501 to which the signaling unit 200 is relevant. On the other hand, the signaling unit 200 should not be taken into consideration if the vehicle 100 is in the bypass lane 502.

The vehicle guidance system 101 can be configured to ascertain (e.g. to receive from a vehicle-external unit 300) map data relating to the junction 500. The map data can comprise a map attribute relating to the at least one signaling unit 200 of the junction 500. The map attribute for a signaling unit 200 can indicate the position of the signaling unit 200 (relative to a stop line of the junction 500 and/or relative to one or more lanes 501, 502 of the junction 500).

The map data for the junction 500 can also indicate that the junction 500 has a bypass lane 502 in which a vehicle 100 can travel, in particular can have longitudinal and/or lateral guidance performed for it in an automated manner, without taking into consideration the signaling state of the one or more signaling units 200 of the junction 500. The map data can have in particular a map attribute for a fictitious or virtual signal transmitter 201 or for a virtual signal group for the bypass lane 502. The map attribute can indicate that the fictitious or virtual signal transmitter 201 for the bypass lane 502 can have only a single signaling state (e.g. “Green”).

The vehicle guidance system 101 can therefore be configured to take the map data for the junction 500 as a basis for ascertaining that the junction 500 has a bypass lane 502 (possibly with a fictitious or virtual signal transmitter 201). In addition, the vehicle guidance system 101 can be configured to determine (on the basis of the environment data and/or on the basis of the position data) that the vehicle 100 is in the bypass lane 502. The automated longitudinal and/or lateral guidance of the vehicle 100 at the junction 500 can then be performed without taking into consideration the one or more signaling units 200, in particular without taking into consideration the signaling state of the one or more signaling units 200. As such, e.g. erroneous slowing of the vehicle 100 at the junction 500 can be prevented in a reliable manner if the vehicle 100 is in the bypass lane 502.

The vehicle-external unit 300 can be configured to ascertain environment data relating to the junction 500 from one or more vehicles 100 and/or for one or more journeys at the junction 500. The environment data may have been transmitted to the vehicle-external unit 300 e.g. via a communication unit 301. The vehicle-external unit 300 can further be configured to analyze the environment data in order to detect whether or not the junction 500 has a bypass lane 502. In particular, it is possible to verify whether the junction 500 has a lane that goes past to the right of a signaling unit 200 (in particular to the right of all of the signaling units 200 of the junction 500, or the approach to the junction 500). Such a lane can be identified as a bypass lane 502.

The vehicle-external unit 300 can further be configured to create or update map data relating to the junction 500. In particular, a map attribute relating to the detected bypass lane 502 can be included in the map data. Furthermore, a map attribute for a fictitious or virtual signal transmitter 201 or for a fictitious or virtual signal group for the bypass lane 502 can be included in the map data. The map data can then be used, as outlined above, by a vehicle guidance system 101 in order to produce automated longitudinal and/or lateral guidance for a vehicle 100 at the junction 500. This allows the quality, convenience and safety of the automated longitudinal and/or lateral guidance of a vehicle 100 at the junction 500 to be increased.

There can be junctions 500 at which all of the signal transmitters 201 of a set of signals 200 change in sync, that is to say there is only a single signal group, but it is nevertheless not possible to perform longitudinal guidance for a vehicle 100 at the approach to the intersection in an automated manner on the basis of the signaling state of the set of signals 200. This can be the case in particular if there are one or more lanes 502 that are not controlled by the traffic signal 200. This can be the case for a so-called bypass lane (FIG. 5a) and/or for a protected left turn (FIG. 5a).

A bypass lane can be a lane 502 at an intersection 500 having a traffic signal 200 that is not changed by the installation 200. Vehicles 200 in this lane 502 can pass the traffic signal 200 without needing to pay attention to the traffic lights. This usually concerns right-turn lanes, often at intersections 500 with freeway approaches. A protected left turn can be present at a junction 500 for which a traffic signal 200 is relevant only to left turns in order to be able to cross the opposite carriageway safely. All other lanes 502 are then not affected by the traffic signal 200.

At a junction 500 having a bypass lane 502, it may happen that the aUCC driving function triggers slowing to red traffic lights 200 even though the vehicle 100 is in the bypass lane 502. This can happen in particular if the map data indicate only a single signal group, and so the driving function assumes that the signaling state of the single signal group is also relevant to the lane 502 currently being used by the vehicle 100.

The environment data pertaining to a multiplicity of vehicles 100 and/or pertaining to a multiplicity of journeys at a junction 500 having a bypass lane 502 can be taken as a basis for ascertaining the positions of the individual signal transmitters 201 and/or of the lane markings at the junction 500. The vehicle trajectories of the individual vehicles 100 and/or journeys and/or the profiles of the lane markings can be taken as a basis for using the geometry of the traffic signal 200 at the junction 500 to ascertain in an automated manner whether one or more lanes 502 go past to the right of the traffic signal 200 (and are therefore bypass lanes 502).

A further (virtual) signal group can then be added to the map data, with the result that the map data indicate that the junction 500 has multiple signal groups, which may have different signaling states. This can result in the UCC driving function being operated in the manual mode, and so red traffic lights are optionally taken into consideration only if the driver of the vehicle 100 confirms that the traffic lights are to be taken into consideration. On the other hand, automated longitudinal and/or lateral guidance (without slowing at the traffic lights) can be produced in the bypass lane 502.

A bypass lane 502 can be detected e.g. by way of inconsistency detection. This involves the data provided by vehicles 100 being able to be taken as a basis for detecting that a statistically significant number of vehicles 100 have passed a traffic signal 200 even though all of the signal transmitters 201 of the traffic signal 200 were red. From this, it can be concluded that there must be one or more lanes 502 that are not controlled by the traffic signal 200.

Alternatively, or additionally, a bypass lane 502 can be detected by analyzing the intersection geometry (e.g. in order to detect a lane 502 that goes past to the right of a signal transmitter 201). In particular, it is possible to detect that the junction 500 has at least one lane 502 that does not have a signal transmitter 201 arranged to the right of the lane 502. Alternatively, or additionally, it is possible to detect that the junction 500 has at least one lane 502 for which all of the signal transmitters 201 on the approach to the junction 500 are arranged to the left of the lane 502.

This can be ascertained e.g. by evaluating a lane model of the junction 500 and the averaged vehicle trajectories of the vehicles 100 compared to the position of the signal transmitters 201 of the traffic signal 200 and the street topology.

FIG. 6 shows a flowchart for a (possibly computer-implemented) method 600 for detecting a bypass lane 502 at a junction 500 having at least one traffic signal 200. The traffic signal 200 can have one or more different signal groups, each comprising one or more signal transmitters 201. A bypass lane 502 can be a lane at the junction 500 to which no traffic signal 200 of the junction 500 is relevant.

The method 600 comprises ascertaining 601 travel data pertaining to at least one motor vehicle 100 for at least one journey at the junction 500. The travel data can comprise environment data from one or more environment sensors 103 (in particular from a camera) of the vehicle 100 and/or trajectory data relating to a travel trajectory of the vehicle 100 for the journey at the junction 500. The environment data can indicate the environment of the vehicle 100 for the journey at the junction 500. The trajectory data can indicate the sequence of positions (e.g. GPS coordinates) of the vehicle 100 for the journey at the junction 500. The trajectory data can be ascertained using a position sensor and/or on the basis of the vehicle odometry.

In addition, the method 600 comprises taking the travel data, in particular taking the trajectory data, as a basis for ascertaining 602 a possible travel trajectory for vehicles 100 at the junction 500. The possible travel trajectory can indicate what path a vehicle 100 can take at the junction 500. Alternatively, or additionally, the possible travel trajectory can indicate a possible lane at the junction 500.

The method 600 further comprises taking the travel data, in particular taking the environment data, as a basis for ascertaining 603 arrangement information relating to the arrangement of the traffic signal 200 relative to the possible travel trajectory. In particular, it is possible to check whether the one or more signal transmitters 201, in particular all of the signal transmitters 201, of the traffic signal 200 are arranged to the left of the possible travel trajectory. If this is the case, the possible travel trajectory possibly corresponds to a bypass lane 502.

The method 600 can therefore comprise detecting 604 a bypass lane 502 of the junction 500 on the basis of the arrangement information.

The measures described in this document can be used to detect and take into consideration bypass lanes 502 at traffic junctions 500 in a reliable manner, allowing the convenience and safety of a driving function for automated longitudinal guidance at traffic junctions 500 to be increased.

The present invention is not limited to the exemplary embodiments shown. In particular, it should be remembered that the description and the figures are intended only to illustrate the principle of the proposed methods, devices and systems.

1-8. (canceled)

9. A device, comprising:
a processor configured to execute software instructions so as to configure the device to:
receive travel data pertaining to at least one motor vehicle for at least one journey at a junction having at least one traffic signal, wherein the travel data includes environment data from one or more environment sensors of the vehicle and/or trajectory data reflecting a travel trajectory of the vehicle for the journey at the junction;
determine at least one possible travel trajectory for vehicles at the junction from the travel data;
determine arrangement information reflecting an arrangement of the traffic signal relative to the possible travel trajectory from the travel data;
detect a bypass lane of the junction from the arrangement information; and
adjust an automated longitudinal guidance function of the at least one motor vehicle based on the detected bypass lane.

10. The device according to claim 9, wherein the processor further configures the device to:
determine, based on the arrangement information: that no signal transmitters of the traffic signal are arranged on a right-hand side of the possible travel trajectory, and/or that all of the signal transmitters of the traffic signal are arranged on a left-hand side of the possible travel trajectory; and
ascertain whether the travel trajectory is in the bypass lane of the junction based on the determination that no signal transmitters of the traffic signal are arranged on a right-hand side of the possible travel trajectory, and/or that all of the signal transmitters of the traffic signal are arranged on a left-hand side of the possible travel trajectory.

11. The device according to claim 9, wherein the processor further configures the device to:
receive the travel data from a multiplicity of vehicles and/or for a multiplicity of journeys at the junction via a communication connection; and
determine the possible travel trajectory from the trajectory data from the multiplicity of vehicles and/or for the multiplicity of journeys.

12. The device according to claim 9, wherein the processor further configures the device to:
create and/or update map data for the junction based on the detected bypass lane; and/or
include a map attribute for a virtual signal group of the traffic signal for the detected bypass lane in the map data.

13. The device according to claim 9,
wherein the bypass lane is a right-turn lane without a signal transmitter at the junction;
wherein the bypass lane is a lane on the right next to a left-turn lane, the traffic signal applying to the left-turn lane; and/or
wherein the bypass lane is a lane of the junction without a traffic signal.

14. A vehicle guidance system for providing automated longitudinal guidance of a vehicle at a junction having a traffic signal, wherein the vehicle guidance system comprises:
a processor configured to execute software instructions so as to configure the vehicle guidance system to:
for a journey on an approach to the junction, receive map data reflecting the junction, wherein the map data indicates that the traffic signal comprises multiple differently changing signal groups, one of the signal groups being associated with a bypass lane at the junction; and
to respond thereto by operating a driving function in a manual mode, in which the automated longitudinal guidance of the vehicle at the junction based on a signaling state of the traffic signal, is considered only after confirmation by a user of the vehicle.

15. The vehicle guidance system according to claim 14, wherein
the vehicle guidance system is configured to operate the driving function in an automatic mode at a junction having a traffic signal that has only one signal group; and
the signaling state of the traffic signal is considered for the automated longitudinal guidance of the vehicle at the junction automatically in the automatic mode.

16. A method for adjusting an automated longitudinal guidance function of at least one motor vehicle, the method comprising:
ascertaining travel data pertaining to the at least one motor vehicle for at least one journey at a junction having at least one traffic signal, wherein the travel data includes environment data from one or more environment sensors of the vehicle and/or trajectory data relating to a travel trajectory of the vehicle for the journey at the junction;
determining at least one possible travel trajectory for vehicles at the junction from the travel data;
determining arrangement information reflecting an arrangement of the traffic signal relative to the possible travel trajectory from the travel data;
detecting a bypass lane of the junction from the arrangement information; and
adjusting an automated longitudinal guidance function of the at least one motor vehicle based on the detected bypass lane.
